(19) United States
(12) Patent Application Publication
(10) Pub. No.: US 2012/0038913 A1
(43) Pub. Date: Feb. 16, 2012

(54) OPTICAL MEASUREMENT INSTRUMENT EQUIPPED WITH TRANSPORTATION PROTECTION

(75) Inventors: Aarne Torkkeli, Lieto (FI); Jyrki Laitinen, Kuusisto (FI); Christer Isaksson, Turku (FI)

(73) Assignee: WALLAC OY, TURKU (FI)

(21) Appl. No.: 13/203,872

(22) PCT Filed: Feb. 18, 2010
(86) PCT No.: PCT/FI10/50107

§ 371 Date: Nov. 2, 2011

Related U.S. Application Data
(60) Provisional application No. 61/157,626, filed on Mar. 5, 2009.

(30) Foreign Application Priority Data
Mar. 5, 2009 (FI) 20095217

(51) Int. Cl. G01N 21/01; B65B 55/00

(52) U.S. Cl. 356/244; 53/410

(57) ABSTRACT

An optical measurement instrument, which is equipped with transportation protection, includes a body structure (201), a mechanical support element(202) for supporting an optical interface, a moveably supported receptable element (211) for receiving a sample plate and located between the mechanical support element and the body structure, and a detachable transportation protection element (212-215) arranged to mechanically restrict movements of the receptable element and the mechanical support element. The transportation protection element is arranged to be pressed between the mechanical support element (202) and the body structure (201). Hence, for the transportation protection, there is no need to use e.g. a bolt that may be more laborious to install and remove than the transportation protection element to be pressed between the mechanical support element (202) and the body structure (201).

### FIELD OF THE INVENTION

The invention relates to an arrangement and a method for equipping an optical measurement instrument with transportation protection. Furthermore, the invention relates to an optical measurement instrument equipped with transportation protection.

### BACKGROUND

The work in analytical biochemical laboratories and in clinical laboratories is often based on different optical measurements, which can be, for example but not necessarily, absorption measurements, photoluminescence measurements, and/or chemiluminescence measurements. Further, there is an analysing method called Amplified Luminescent Proximity Homogeneous Assay or AlphaScreen™.

FIG. 1a shows a schematic illustration of a known optical measurement instrument suitable for performing some or all of the measurements of the kind mentioned above. FIG. 1b shows schematic illustration of a view seen downwards from line A-A of FIG. 1a. Samples 151, 152, 153, 154, 155, 156, 157 to be measured are stored in sample wells that are built on a sample plate 120 e.g. a microtitration plate. The optical measurement instrument includes an excitation light source 121 arranged to produce an excitation beam. The excitation light source can be for example a laser source or a flash lamp such as a xenon flash lamp. The excitation beam is focused to a light guide 122 that can be e.g. a fiber bundle. The light guide 122 is connected to an optical module 123 that constitutes an optical interface arranged to direct the excitation beam to the sample 153 to be measured and/or to collect an emission beam from the sample to be measured. The emission beam is conducted via a light guide 124 to a detector 125 arranged to detect the emission beam and to produce a detection signal responsive to the detected emission beam. The detector can be for example a photodiode or a photomultiplier tube.

The optical measurement instrument includes a mechanical support element 102 onto which the optical module 123 constituting the optical interface can be fastened. The mechanical support element 102 is connected to a body structure 101 of the optical measurement instrument with the aid of threaded rods 103 and 104 and counterparts 105 and 106 so as to allow the distance D from the optical interface to the measured and/or excited sample 153 to be adjusted. The counterparts 105 and 106 may include, for example, servomotors arranged to move the mechanical support element 102 in the positive or negative z-direction of a co-ordinate system 190 in order to adjust the distance D.

The optical measurement instrument includes a receptable element 111 that is suitable for receiving the sample plate 120. The optical measurement instrument includes mechanical support elements arranged to moveably support the receptable element 111 with respect to the body structure 101. These mechanical support elements include a support rail 108 and guide elements 109 and 110 shown in FIG. 1b. The support rail 108 is supported relative to the body structure 101 with the aid of the guide elements 109 and 110 in such a manner that the support rail is movable in the directions of a two-headed arrow 126 shown in FIG. 1b. The receptable element 111 is connected with the aid of a part 107 to the support rail 108 in such a manner that the receptable element is capable of sliding along the support rail in the longitudinal direction of the support rail, i.e. the receptable element is movable in the directions of a two-headed arrow 127 shown in FIG. 1b. Hence, the samples stored in the sample wells of the sample plate 120 are movable in the xy-plane defined by the co-ordinate system 190. Due to the fact that the samples are movable in the xy-plane, the samples can be measured in a temporally successive manner so that each sample is in turn the sample that is currently being measured.

As the optical measurement instrument includes movable parts such as the mechanical support element 102 and the receptable element 111, the optical measurement instrument is preferably equipped with transportation protection during transportation, e.g. during shipping. A known solution is to use a bolt 128 or some other suitable pin for locking the mechanical support element 102 and the receptable element 111 to the body structure 101. The bolt 128 is capable of acting as a transportation protection element which is arranged to prevent the movable parts from moving during transportation and which has to be removed before the normal use of the optical measurement instrument. An inconvenience related to a technical solution of the kind described above is the work needed for installing the bolt 128 or another suitable pin to the optical measurement instrument before the transportation and also the work needed for removing the bolt or the other suitable pin after the transportation. For example, to be able to install the bolt 128 to the optical measurement instrument it is required that a hole 129, FIG. 1b, of the part 107 is sufficiently well aligned with the respective holes in the body structure 101 and in the mechanical support element 102.

### SUMMARY

In accordance with a first aspect of the invention, there is provided a new arrangement for equipping an optical measurement instrument with transportation protection, the said optical measurement instrument comprising:
a body structure,
a first mechanical support element for supporting an optical interface capable of directing an excitation beam to a sample to be measured and/or to collect emission beam from the sample,
a receptable element for receiving a sample plate and being located in an area between the first mechanical support element and the body structure, and
second mechanical support elements arranged to moveably support the receptable element with respect to the body structure.

The arrangement according to the invention comprises a detachable transportation protection element that is arranged to be pressed between the first mechanical support element and the body structure so as to mechanically restrict movement of the receptable element with respect to the body structure.

As the transportation protection element is arranged to be pressed between the first mechanical support element and the body structure, there is no need to install e.g. a bolt or some other pin into holes of different parts of the optical measurement instrument and thus the need for positioning the said parts in such a manner that the said holes are aligned with respect to each other is avoided.

In conjunction with such an optical measurement instrument that comprises driving elements that can be used for adjusting the distance between the first mechanical support element and the body structure, the transportation protection element can be arranged to be pressed between the first mechanical support element and the body structure for example with the aid of the above-mentioned driving elements. The driving elements may comprise for example one or more threaded rods having the thread pitch angle so small that each threaded rod is self-locking by friction to a respective counterpart in the longitudinal direction of the one or more threaded rods. Hence, the first mechanical support element and the receptable element are bound to the body structure with the aid of the above-mentioned driving elements and the transportation protection element. It is also possible that the transportation protection element is arranged to expand as a response to a control action directed to the transportation protection element in order to arrange the transportation protection element to be pressed between the first mechanical support element and the body structure. The transportation protection element can be, for example, a balloon-like bag that is expanded with e.g. pressurised air.

In accordance with a second aspect of the invention, there is provided a new optical measurement instrument. The optical measurement instrument according to the invention is equipped with transportation protection and it comprises:
a body structure,
a first mechanical support element for supporting an optical interface capable of directing an excitation beam to a sample to be measured and/or to collect emission beam from the sample,
a receptable element for receiving a sample plate and being located in an area between the first mechanical support element and the body structure,
second mechanical support elements arranged to moveably support the receptable element with respect to the body structure, and
a transportation protection element that is detachable and arranged to mechanically restrict movement of the receptable element with respect to the body structure,
   wherein the transportation protection element is arranged to be pressed between the first mechanical support element and the body structure.

In accordance with a third aspect of the invention, there is provided a new method for equipping an optical measurement instrument with transportation protection, the optical measurement instrument comprising:
a body structure,
a first mechanical support element for supporting an optical interface capable of directing an excitation beam to a sample to be measured and/or to collect emission beam from the sample,
a receptable element for receiving a sample plate and being located in an area between the first mechanical support element and the body structure, and
second mechanical support elements arranged to moveably support the receptable element with respect to the body structure.

The method according to the invention comprises arranging a detachable transportation protection element to be pressed between the first mechanical support element and the body structure so as to arrange the transportation protection element to mechanically restrict movement of the receptable element with respect to the body structure.

A number of exemplifying embodiments of the invention are described in accompanied dependent claims.

Various exemplifying embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open expressions that do not exclude the existence of also unrecited features. The features recited in depending claims are mutually freely combinable unless otherwise explicitly stated.

### BRIEF DESCRIPTION OF THE FIGURES

The exemplifying embodiments of the invention and their advantages are explained in greater detail below in the sense of examples and with reference to the accompanying drawings, in which:

FIG. 1a shows a schematic illustration of an optical measurement instrument according to the prior art,

FIG. 1b shows a schematic illustration of a view seen downwards from line A-A of FIG. 1a,

FIG. 2a shows a schematic illustration of an optical measurement instrument that is equipped according to an embodiment of the invention with a transportation protection element suitable for providing transportation protection,

FIG. 2b shows a schematic illustration of the optical measurement instrument of FIG. 2a in a situation in which the transportation protection element is being used for providing the transportation protection,

FIG. 2c shows a schematic illustration of a view seen downwards from line A-A of FIG. 2b,

FIG. 3a shows a schematic illustration of an optical measurement instrument that is equipped according to an embodiment of the invention with a transportation protection element suitable for providing transportation protection,

FIG. 3b shows a schematic illustration of the optical measurement instrument of FIG. 3a in a situation in which the transportation protection element is being used for providing the transportation protection,

FIG. 3c shows a schematic illustration of a view seen downwards from line A-A of FIG. 3b,

FIG. 4a shows a schematic illustration of an optical measurement instrument that is equipped according to an embodiment of the invention with a transportation protection element suitable for providing transportation protection,

FIG. 4b shows a schematic illustration of the optical measurement instrument of FIG. 4a in a situation in which the transportation protection element is being used for providing the transportation protection,

FIG. 5a shows a schematic illustration of an optical measurement instrument that is equipped according to an embodiment of the invention with a transportation protection element suitable for providing transportation protection,

FIG. 5b shows a schematic illustration of the optical measurement instrument of FIG. 5a in a situation in which the transportation protection element is being used for providing the transportation protection,

FIG. 6a shows a schematic illustration of an optical measurement instrument that is equipped according to an embodiment of the invention with a transportation protection element suitable for providing transportation protection,

FIG. 6b shows a schematic illustration of the optical measurement instrument of FIG. 6a in a situation in which the transportation protection element is being used for providing the transportation protection,

FIG. 7a shows a schematic illustration of an optical measurement instrument that is equipped according to an embodiment of the invention with a transportation protection element suitable for providing transportation protection,

FIG. 7b shows a schematic illustration of the optical measurement instrument of FIG. 7a in a situation in which the transportation protection element is being used for providing the transportation protection,

FIG. 7c shows a schematic illustration of a view seen downwards from line A-A of FIG. 7b,

FIG. 8 shows a flow chart of a method according to an embodiment of the invention for equipping an optical measurement instrument with transportation protection, and

FIG. 9 shows a flow chart of a method according to an embodiment of the invention for equipping an optical measurement instrument with transportation protection.

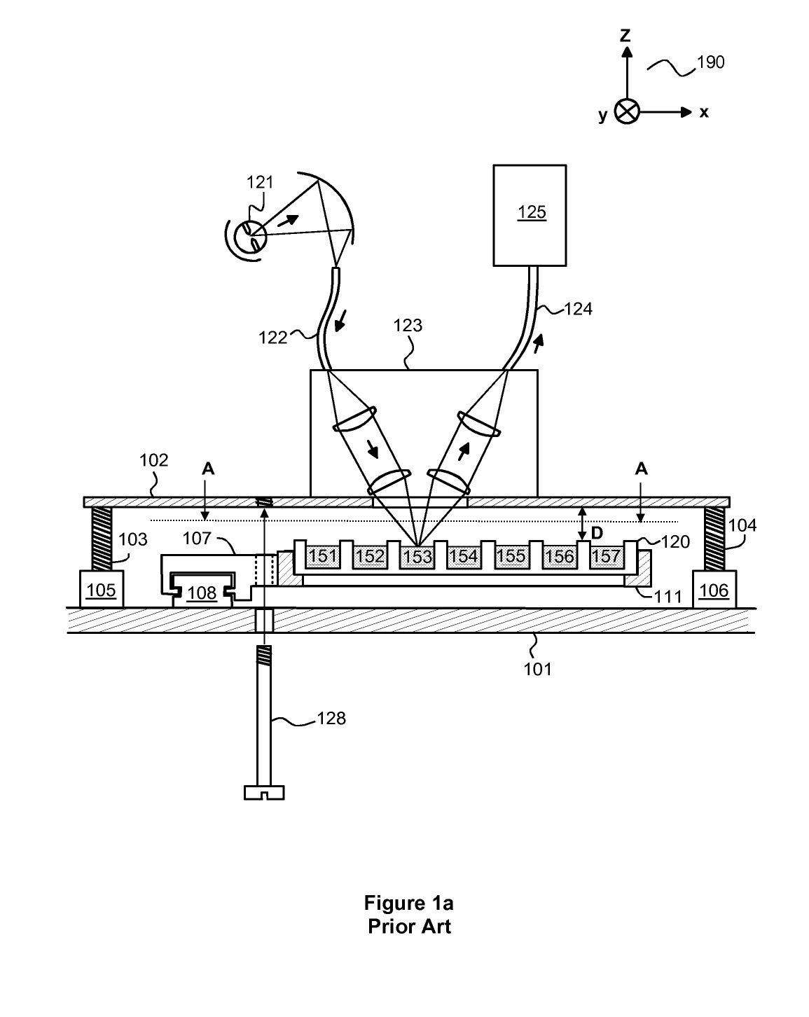

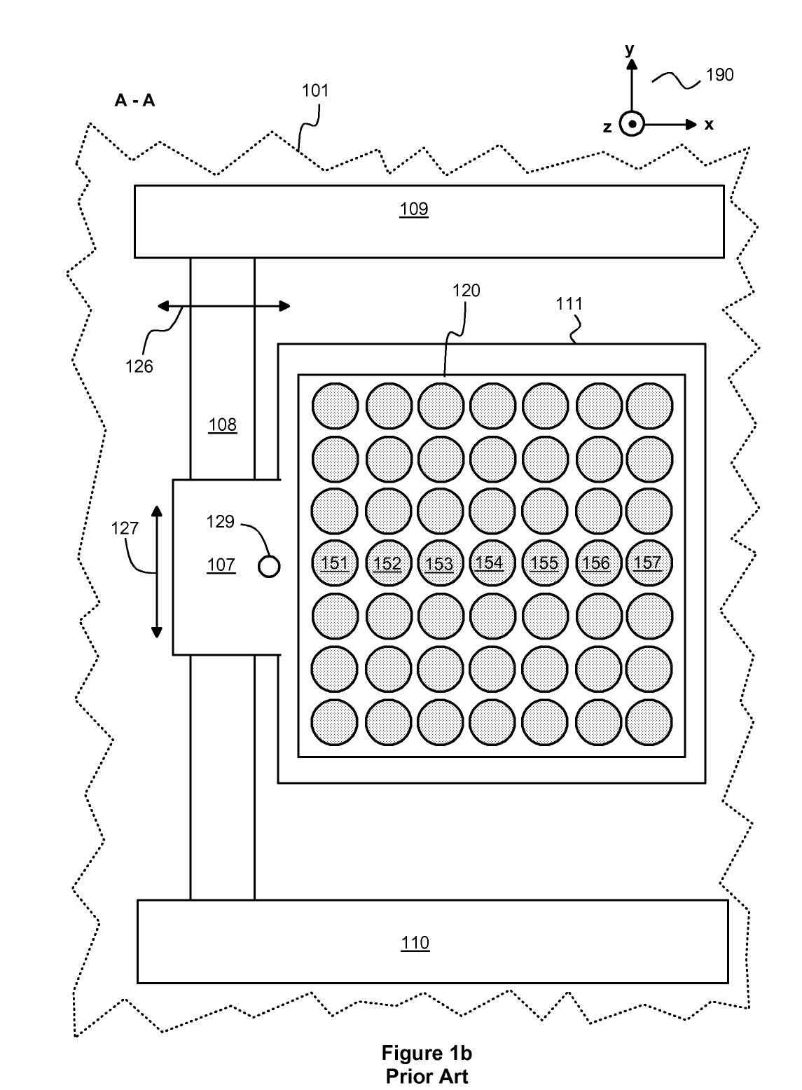

FIGS. 1a and 1b have been explained earlier in this document in conjunction with the background of the invention.

### DESCRIPTION OF THE EMBODIMENTS

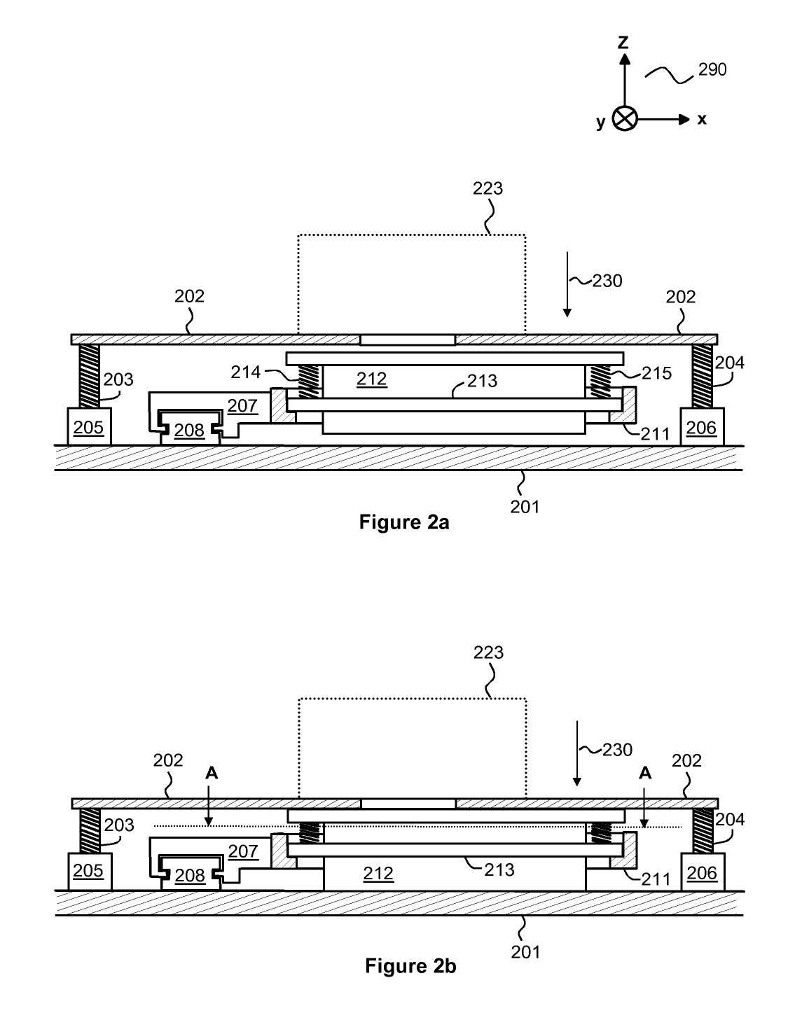

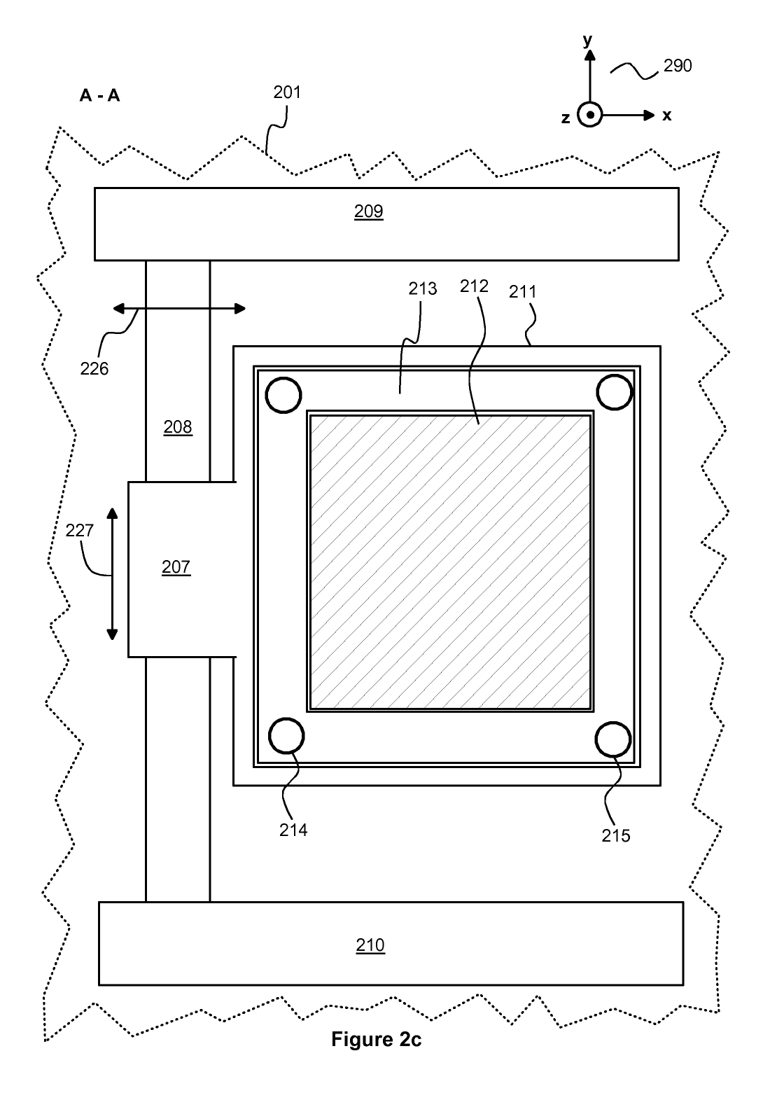

FIG. 2a shows a schematic illustration of an optical measurement instrument that is equipped with a detachable transportation protection element suitable for providing transportation protection. FIG. 2b shows a schematic illustration of the optical measurement instrument in a situation in which the transportation protection element is being used for providing the transportation protection. FIG. 2c shows a schematic illustration of a view seen downwards from line A-A of FIG. 2b.

The optical measurement instrument may include, among others, the following functional elements: an excitation light source, a detector, one or more optical filters, light guides, and an optical interface capable of directing an excitation beam to a sample to be measured and/or to collect emission beam from the sample. One or more of the above-mentioned functional elements may be changeable optical modules that are not necessarily present in the optical measurement instrument during transportation, e.g. shipping. Hence, the above-mentioned functional elements are not shown in FIGS. 2a-2c. Dashed line 223 represents a place for one or more optical components constituting the optical interface.

The optical measurement instrument includes a first mechanical support element 202 that is suitable for supporting the optical interface. As mentioned above, the said optical interface may be a changeable optical module that is not necessarily installed to the first mechanical support element 202, or alternatively the optical interface may include optical components that are integral parts of the optical measurement instrument. The first mechanical support element 202 is connected to a body structure 201 of the optical measurement instrument with the aid of driving elements that allow the first mechanical support element 202 to be moved relative to the body structure 201 in the positive and negative z-directions of a co-ordinate system 290. The co-ordinate system 290 is assumed to be fixed relative to the body structure 201. In the optical measurement instrument shown in FIGS. 2a-2c, the driving elements include threaded rods 203 and 204 and respective counterparts 205 and 206 so as to allow the first mechanical support element 202 to be moved in the positive and negative z-directions of the co-ordinate system 290. The counterparts 205 and 206 may include, for example, servomotors arranged to move the first mechanical support element 202 in the positive and negative z-directions of the co-ordinate system 290. It should be noted that the threaded rods are not the only possible choice for providing the driving elements. The driving elements can as well be based on e.g. a toothed bar and a worm gear.

The optical measurement instrument includes a receptable element 211 that is suitable for receiving a sample plate. The optical measurement instrument includes second mechanical support elements arranged to moveably support the receptable element 211 with respect to the body structure 201. The second mechanical support elements include a support rail 208 and guide elements 209 and 210 shown in FIG. 2b. The support rail 208 is supported relative to the body structure 201 with the aid of the guide elements 209 and 210 in such a manner that the support rail is movable in the directions of a two-headed arrow 226 shown in FIG. 2b. The receptable element 211 is connected with the aid of a part 207 to the support rail 208 in such a manner that the receptable element is capable of sliding along the support rail in the longitudinal direction of the support rail, i.e. the receptable element is movable in the directions of a two-headed arrow 227 shown in FIG. 2b. Hence, the receptable element 211 is movable in the xy-plane defined by the co-ordinate system 190. Due to the fact that the receptable element 211 is movable in the xy-plane, samples can be measured during the normal use of the optical measurement instrument in a temporally successive manner so that each sample is in turn the sample that is currently being measured.

The above-mentioned sample plate is not shown in FIGS. 2a-2c, because, in the situations shown in FIGS. 2a-2c, the optical measurement instrument includes the transportation protection element that is located with respect to the receptable element 211 in a substantially similar manner as the sample plate is intended to locate with respect to the receptable element. The transportation protection element includes a first part 213 that is in mechanical contact with the receptable element 211 in a substantially similar manner as the sample plate is intended to be in mechanical contact with the receptable element. The transportation protection element further includes a second part 212 that is connected to the first part in a flexible manner with the aid of helical springs 214 and 215. The helical springs allow the second part 212 to be pressed against the body structure 201 with the aid of the first mechanical support element 202 in the direction of an arrow 230. FIG. 2b illustrates a situation in which the first mechanical support element 202 presses the second part 212 of the transportation protection element against the body structure 201. The driving elements that include the threaded rods 203 and 204 and the respective counterparts 205 and 206 are advantageously used for making the first mechanical support element 202 to press the second part 212 of the transportation protection element against the body structure 201. The threaded rods 203 and 204 have advantageously the thread pitch angle so small that each threaded rod is self-locking by friction to a respective counterpart 205 or 206 in the longitudinal direction of the threaded rods, i.e. in the z-direction of the co-ordinate system 290. The thread pitch angle can be e.g. 3-10 degrees. Hence, the first mechanical support element 202 and the receptable element 211 are bound to the body structure 201 with the aid of the above-mentioned driving elements and the transportation protection element.

In the following parts of this description of the exemplifying embodiments, a notation such as “the transportation protection element 212-215” means “the transportation protection element including the first part 213, the second part 212, and the helical springs 214 and 215”. Correspondingly, a notation such as “the driving elements 203-206” means “the driving elements including the threaded rods 203 and 204 and the respective counterparts 205 and 206”. The same is valid also for other figures.

As shown in FIG. 2a, the transportation protection element 212-215 is neither in mechanical contact with the first mechanical support element 202 nor in mechanical contact with the body structure 201. Therefore, the transportation protection element can be placed to the receptable element 211 in a similar manner as a sample plate can be placed to the receptable element. After placing the transportation protection element to the receptable element, the receptable element and the transportation protection element can be driven to a desired position with the aid of the second mechanical support elements 207-210 that are arranged to moveably support the receptable element with respect to the body structure. After this, the driving elements that include the threaded rods 203 and 204 and the respective counterparts 205 and 206 can be used for making the first mechanical support element 202 to press the second part 212 of the transportation protection element against the body structure 201. Hence, the optical measurement instrument can be equipped with transportation protection by replacing a sample plate with the transportation protection element 212-215 and by using the same parts of the optical measurement instrument, i.e. the first mechanical support element 201, the second mechanical support elements 207-210, and the driving elements 203-206, that are also used during the normal operation of the optical measurement instrument, i.e. when the optical measurement instrument is used for measuring samples.

In an optical measurement instrument according to an embodiment of the invention a surface of the transportation protection element 212-215 that is in mechanical contact with the body structure 201 is at least partially covered with anti-slip material and/or a surface of the transportation protection element that is in mechanical contact with the first mechanical support element 202 is at least partially covered with anti-slip material. The anti-slip material can be for example rubber.

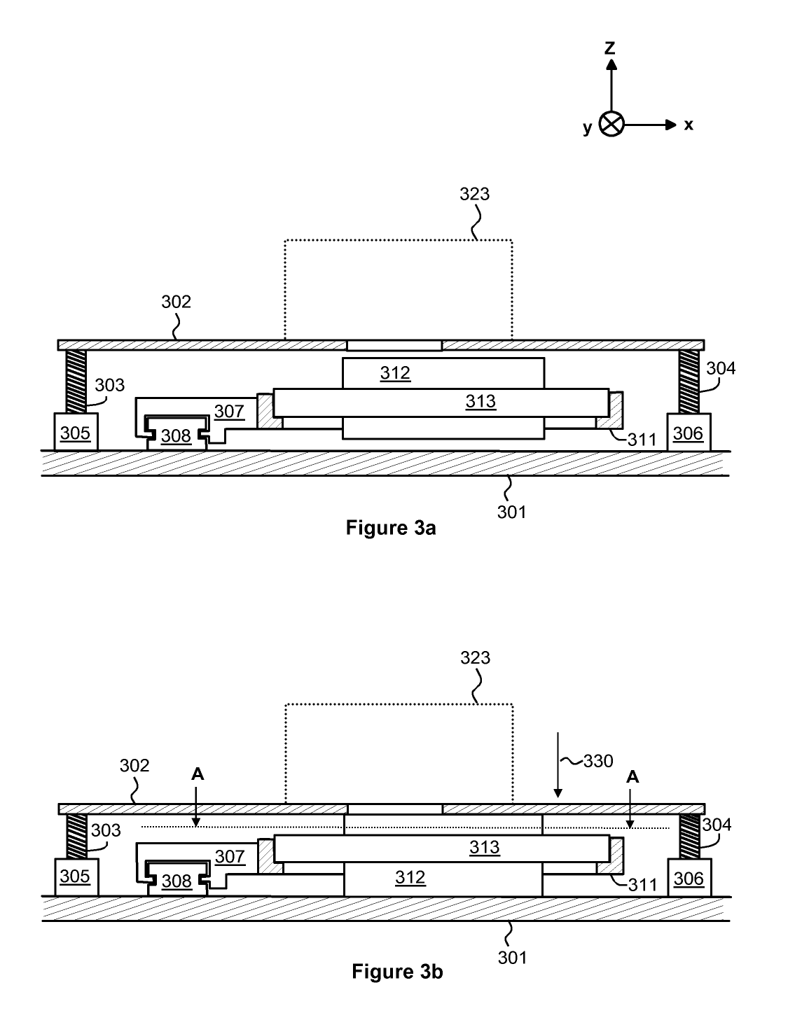

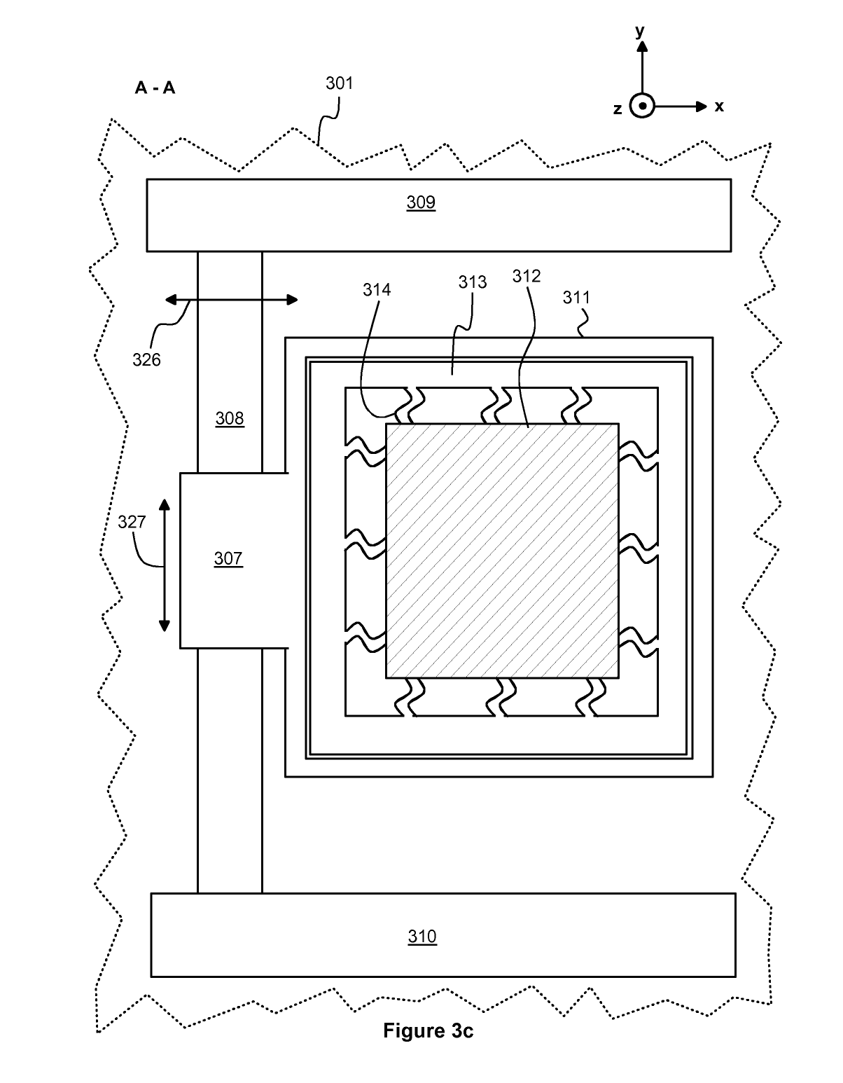

FIG. 3a shows a schematic illustration of an optical measurement instrument that is equipped with a detachable transportation protection element suitable for providing transportation protection. FIG. 3b shows a schematic illustration of the optical measurement instrument in a situation in which the transportation protection element is being used for providing the transportation protection. FIG. 3c shows a schematic illustration of a view seen downwards from line A-A of FIG. 3b. Except for the transportation protection element, the optical measurement instrument can be otherwise similar to the optical measurement instrument presented in FIGS. 2a-2c. Hence, the reference numbers 301, 302, 303, 304, 305, 306, 307, 308, 309, 310, 311, 323, 326, 327, and 330 shown in FIGS. 3a-3c correspond to reference numbers 201-211, 223, 226, 227, and 230 shown in FIGS. 2a-2c, respectively.

The transportation protection element includes a first part 313 that is in mechanical contact with the receptable element 311 in a substantially similar manner as a sample plate is intended to be in mechanical contact with the receptable element.

The transportation protection element further includes a second part 312 connected to the first part 312 in a flexible manner so as to allow the second part to be pressed against the body structure 301 with the aid of the first mechanical support element 302 in the direction of the arrow 330, as shown in FIG. 3b. The transportation protection element is made of elastic material and the first part 313 of the transportation protection element is connected to the second part 312 of the transportation protection element with strips of said elastic material as shown in FIG. 3c. The reference number 314 shown in FIG. 3c refers to one of the said strips. The transportation protection element shown in FIGS. 3a-3c can be cast as a single piece. The elastic material can be for example soft plastics or rubber.

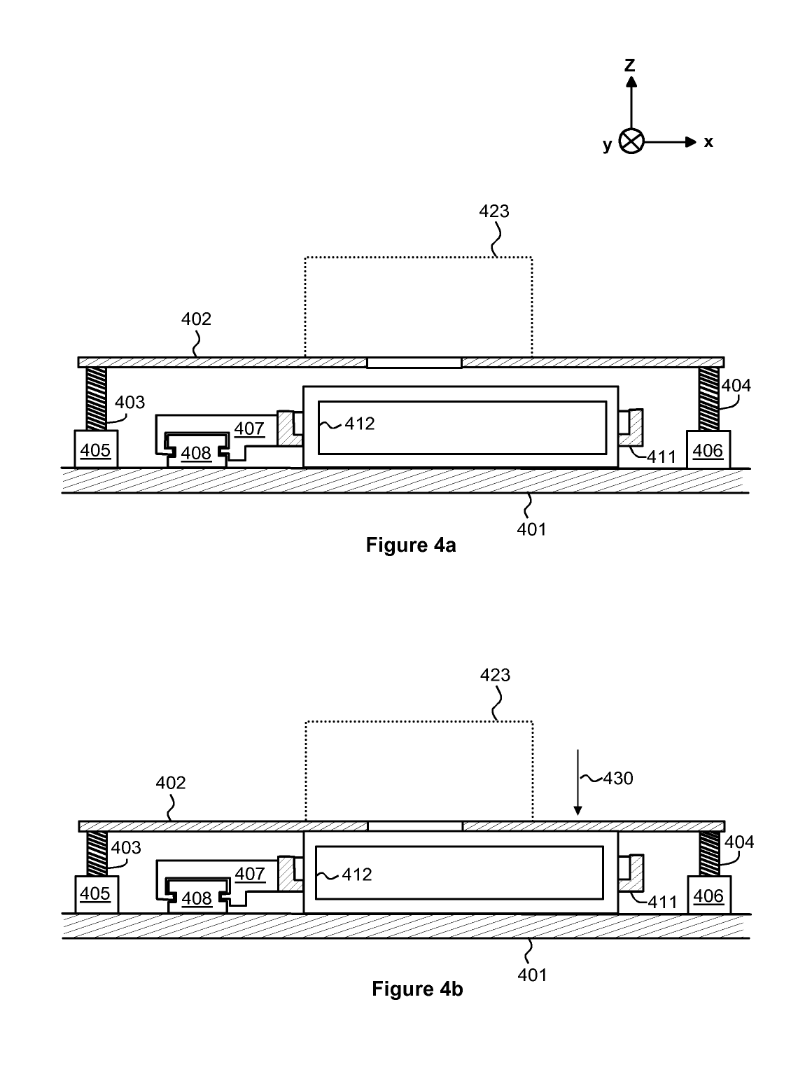

FIG. 4a shows a schematic illustration of an optical measurement instrument that is equipped with a detachable transportation protection element suitable for providing transportation protection. FIG. 4b shows a schematic illustration of the optical measurement instrument in a situation in which the transportation protection element is being used for providing the transportation protection. Except for the transportation protection element, the optical measurement instrument can be otherwise similar to the optical measurement instrument presented in FIGS. 2a-2c. Hence, the reference numbers 401, 402, 403, 404, 405, 406, 407, 408, 411, 423, and 430 shown in FIGS. 4a and 4b correspond to reference numbers 201-208, 211, 223, and 230 shown in FIGS. 2a and 2b, respectively.

The transportation protection element 412 is a piece of material such as plastics or rubber and it is dimensioned to fit with the receptable element 411 as illustrated in FIGS. 4a and 4b. Due to the gravity, the transportation protection element 412 is in mechanical contact with the body structure 401 also in the situation shown in FIG. 4a. Hence, friction between the transportation protection element 412 and the body structure 401 is a disturbing issue when the transportation protection element 412 is moved to its desired position with the aid of the second mechanical support elements 407, 408 that are arranged to moveably support the receptable element 411. The friction can be minimised by minimising the weight of the transportation protection element e.g. by making the transportation protection element hollow as shown in FIGS. 4a and 4b. In the situation shown in FIG. 4b, the driving elements 403-406 are arranged to make the mechanical support element 402 to press the transportation protection element 412 against the body structure 401 in the direction of the arrow 430.

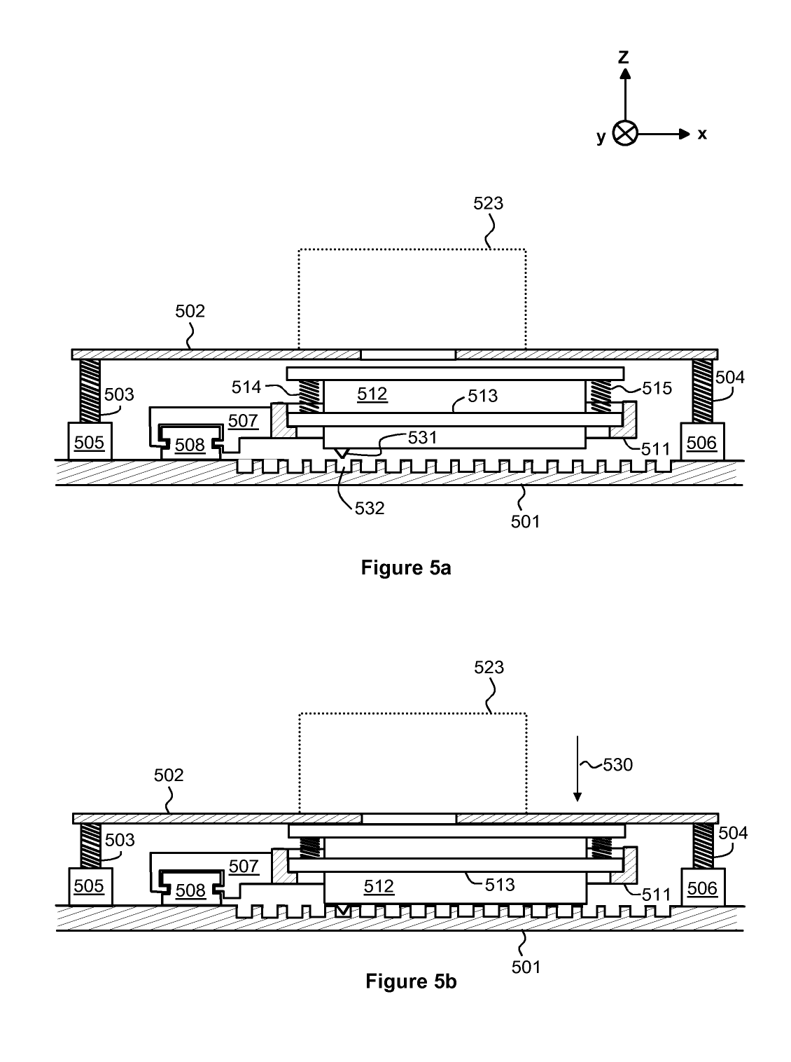

FIG. 5a shows a schematic illustration of an optical measurement instrument that is equipped with a detachable transportation protection element suitable for providing transportation protection. FIG. 5b shows a schematic illustration of the optical measurement instrument in a situation in which the transportation protection element is being used for providing the transportation protection. Except for the transportation protection element and for a body structure 501, the optical measurement instrument can be otherwise similar to the optical measurement instrument presented in FIGS. 2a-2c. Hence, the reference numbers 502, 503, 504, 505, 506, 507, 508, 511, 523, and 530 shown in FIGS. 5a and 5b correspond to reference numbers 202-208, 211, 223, and 230 shown in FIGS. 2a and 2b, respectively.

The transportation protection element includes a first part 513 that is in mechanical contact with the receptable element 511 in a substantially similar manner as the sample plate is intended to be in mechanical contact with the receptable element. The transportation protection element further includes a second part 512 that is connected to the first part in a flexible manner with the aid of springs 514 and 515. The springs allow the second part 512 to be pressed with the aid of the first mechanical support element 502 against the body structure 501 in the direction of the arrow 530. FIG. 5b illustrates a situation in which the first mechanical support element 502 presses the second part 512 of the transportation protection element against the body structure 501. A surface of the second part 512 that is, in the situation shown in FIG. 5b, in mechanical contact with the body structure 501 is equipped with at least one projection 531 that is able to fit with a respective cavity 532 in the body structure. Due to the projection and the cavity, the locking effect achieved is not only based on the friction between the transportation protection element and the body structure. Thus, a smaller pressing force by which the first mechanical support element 502 presses the second part 512 of the transportation protection element may be sufficient than in a case without the said projection and cavity.

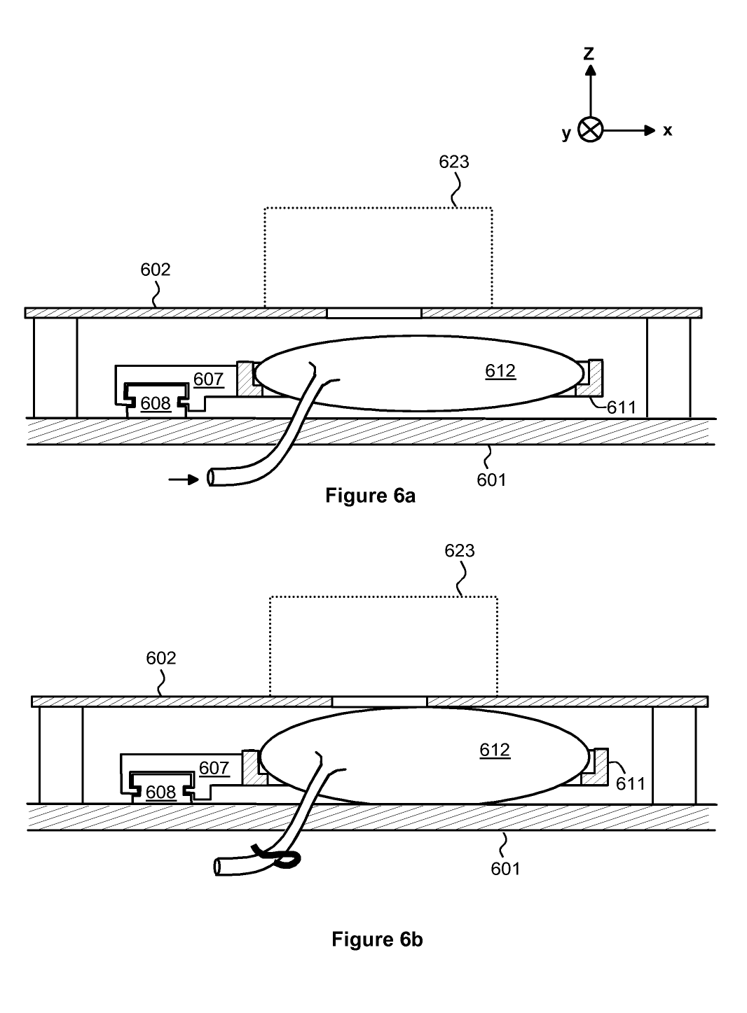

FIG. 6a shows a schematic illustration of an optical measurement instrument that is equipped with a detachable transportation protection element suitable for providing transportation protection. FIG. 6b shows a schematic illustration of the optical measurement instrument in a situation in which the transportation protection element is being used for providing the transportation protection. The reference numbers 601, 602, 607, 608, 611, and 623 shown in FIGS. 6a and 6b correspond to reference numbers 201, 202, 207, 208, 211, and 223 shown in FIGS. 2a and 2b, respectively.

The transportation protection element 612 is arranged to expand as a response to a control action directed to the transportation protection element in order to arrange the transportation protection element to be pressed between the first mechanical support element 602 and the body structure 601. FIGS. 6a and 6b shows an example in which the said transportation protection element is a balloon-like bag made of flexible material e.g. rubber or plastic. The transportation protection element shown in FIGS. 6a and 6b can be expanded, for example, with pressurized air, i.e. the control action directed to the transportation protection element can be supplying pressurized air. Expandable transportation protection elements different from the one shown in FIGS. 6a and 6b are also possible. For example, an expandable transportation protection element may include a spring that is arranged to push parts of the transportation protection element away from each other in order to expand the transportation protection element, and a screw or other control means for forcing the said parts closer to each other against the force generated by the spring. In this case the said control action may be e.g. turning a screw so that the spring is released to expand the transportation protection element. The expandable transportation protection elements of the kind described above are suitable also for cases in which the first mechanical support element 602 is not moveable relative to the body structure 601.

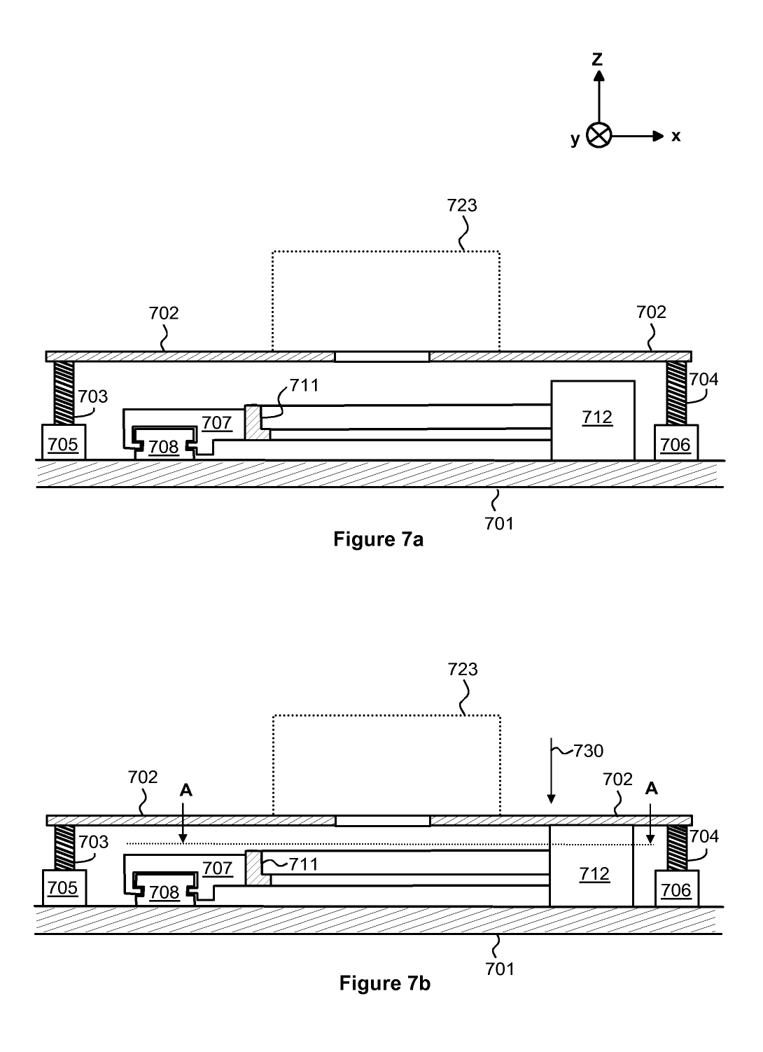

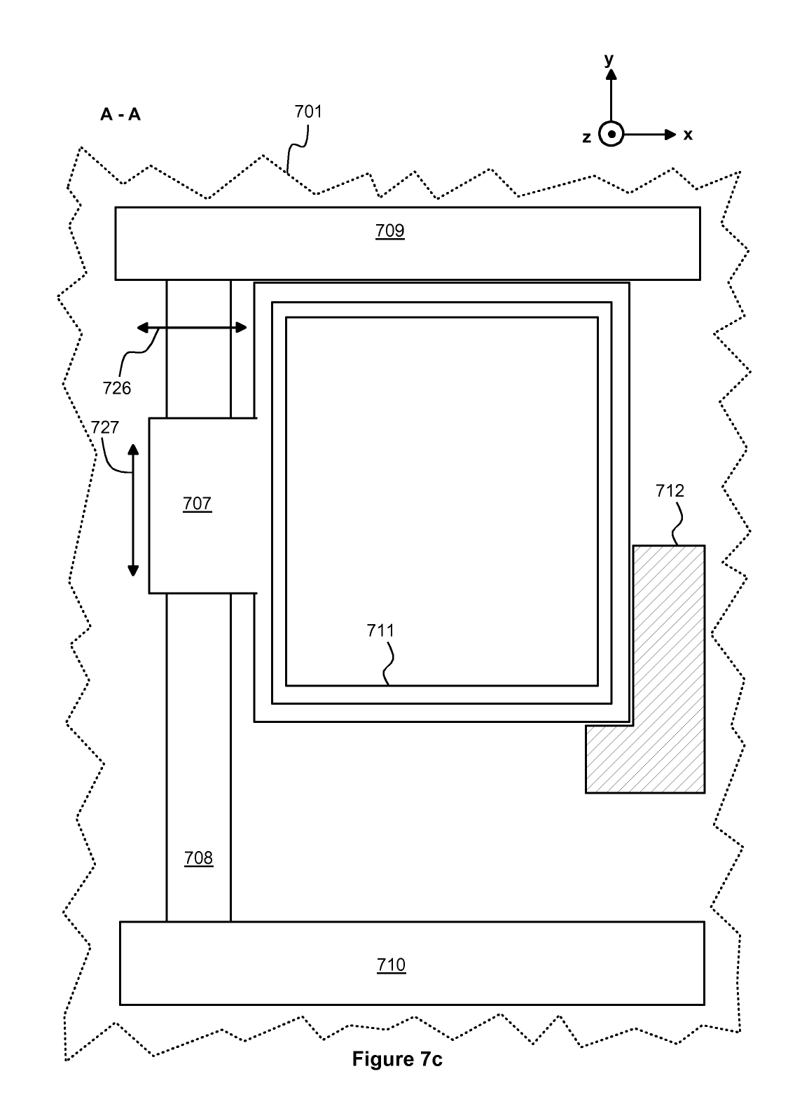

FIG. 7a shows a schematic illustration of an optical measurement instrument that is equipped with a detachable transportation protection element suitable for providing transportation protection. FIG. 7b shows a schematic illustration of the optical measurement instrument in a situation in which the transportation protection element is being used for providing the transportation protection. FIG. 7c shows a schematic illustration of a view seen downwards from line A-A of FIG. 7b. Except for the transportation protection element, the optical measurement instrument can be otherwise similar to the optical measurement instrument presented in FIGS. 2a-2c. Hence, the reference numbers 701, 702, 703, 704, 705, 706, 707, 708, 709, 710, 711, 723, 726, 727, and 730 shown in FIGS. 7a-7c correspond to reference numbers 201-211, 223, 226, 227, and 230 shown in FIGS. 2a-2c, respectively. The transportation protection element 712 is a piece of material such as plastics or rubber and it is positioned with respect to the receptable element 711 as illustrated in FIGS. 7a-7c. A situation in which the first mechanical support element 702 presses the transportation protection element 712 against the body structure 701 in the direction of the arrow 730 as shown in FIG. 7b.

Arrangements according to some exemplifying embodiments of the invention are described below referring to FIGS. 2a-2c, 3a-3c, 4a, 4b, 5a, 5b, 6a, 6b, and 7a-7c, i.e. the numbers mentioned below are the reference numbers shown in the said figures.

An arrangement according to an embodiment of the invention includes a detachable transportation protection element 212-215, 312-314, 412, 512-515, 612, 712 for equipping an optical measurement instrument with transportation protection, the said optical measurement instrument including:
a body structure 201, 301, 401, 501, 601, 701,
a first mechanical support element 202, 302, 402, 502, 602, 702 for supporting an optical interface capable of directing an excitation beam to a sample to be measured and/or to collect emission beam from the sample,
a receptable element 211, 311, 411, 511, 611, 711 for receiving a sample plate and being located in an area between the first mechanical support element and the body structure, and
second mechanical support elements 207-210, 307-310, 407, 408, 507, 508, 607, 608, 707-710 arranged to moveably support the receptable element with respect to the body structure.

In the above-mentioned arrangement, the detachable transportation protection element is arranged to be pressed between the first mechanical support element and the body structure so as to mechanically restrict movement of the receptable element with respect to the body structure.

In an arrangement according to an embodiment of the invention, the transportation protection element 212-215, 312-314, 412, 512-515, 612 is located with respect to the receptable element in a substantially similar manner as a sample plate is intended to locate with respect to the receptable element.

In an arrangement according to an embodiment of the invention, the transportation protection element includes:
a first part 213, 313 in mechanical contact with the receptable element in a substantially similar manner as a sample plate is intended to be in mechanical contact with the receptable element, and
a second part 212, 312 connected to the first part in a flexible manner so as to allow the second part to be pressed against the body structure 201, 301 with the aid of the first mechanical support element 202, 302.

In an arrangement according to an embodiment of the invention, the transportation protection element 312-314 is made of elastic material and the first part 313 of the transportation protection element is connected to the second part 312 of the transportation protection element with strips 314 of said elastic material.

In an arrangement according to an embodiment of the invention, a surface of the transportation protection element that is in mechanical contact with the body structure is at least partially covered with anti-slip material.

In an arrangement according to an embodiment of the invention, the transportation protection element 212-215, 312-314, 412, 512-515, 712 is arranged to be pressed between the first mechanical support element 202, 302, 402, 502, 702 and the body structure 201, 301, 401, 501, 701 with the aid of driving elements 203-206, 303-306, 403-406, 503-506, 703-706 of the optical measurement instrument, the driving elements being arranged to move the first mechanical support element relative to the body structure.

In an arrangement according to an embodiment of the invention, the first mechanical support element 202 is locked to a position, in which it presses the transportation protection element, with the aid of driving elements that include at least one threaded rod 203, 204 having the thread pitch angle so small that the threaded rod is self-locking by friction to a respective counterpart 205, 206 in the longitudinal direction of the threaded rod.

In an arrangement according to an embodiment of the invention, the transportation protection element 612 is arranged to expand as a response to a control action directed to the transportation protection element in order to arrange the transportation protection element to be pressed between the first mechanical support element 602 and the body structure 601.

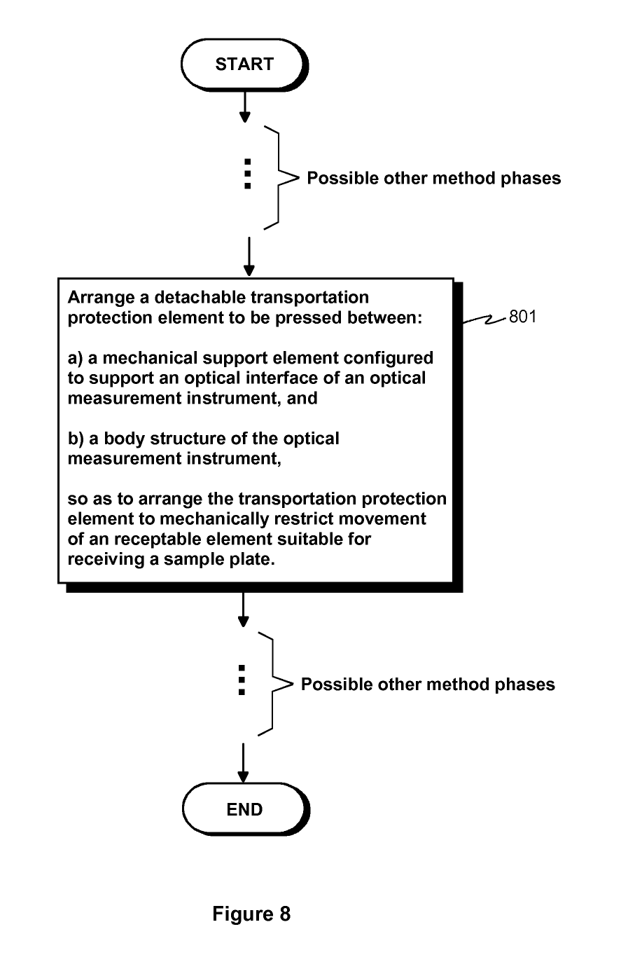

FIG. 8 shows a flow chart of a method according to an embodiment of the invention for equipping an optical measurement instrument with transportation protection, wherein the optical measurement instrument includes:
a body structure,
a first mechanical support element for supporting an optical interface capable of directing an excitation beam to a sample to be measured and/or to collect emission beam from the sample,
a receptable element for receiving a sample plate and being located in an area between the first mechanical support element and the body structure, and
second mechanical support elements arranged to moveably support the receptable element with respect to the body structure,

The above-mentioned method includes arranging, in phase 801, a detachable transportation protection element to be pressed between the first mechanical support element and the body structure so as to arrange the transportation protection element to mechanically restrict movement of the receptable element with respect to the body structure.

The method may include possible other method phases such as, for example, manufacturing or assembling the transportation protection element and/or packaging the optical measurement instrument.

In a method according to an embodiment of the invention, the transportation protection element is placed with respect to the receptable element in a substantially similar manner as a sample plate is intended to locate with respect to the receptable element.

In a method according to an embodiment of the invention, a surface of the transportation protection element that is in mechanical contact with the body structure is at least partially covered with anti-slip material.

In a method according to an embodiment of the invention, the method includes pressing, with the aid of the first mechanical support element, the transportation protection element against the body structure.

In a method according to an embodiment of the invention, the first mechanical support element is pressed against the transportation protection element using least one threaded rod having a thread pitch angle so small that the threaded rod is self-locking by friction to a respective counterpart in the longitudinal direction of the threaded rod.

In a method according to an embodiment of the invention, the method includes expanding the transportation protection element in order to arrange the transportation protection element to be pressed between the first mechanical support element and the body structure.

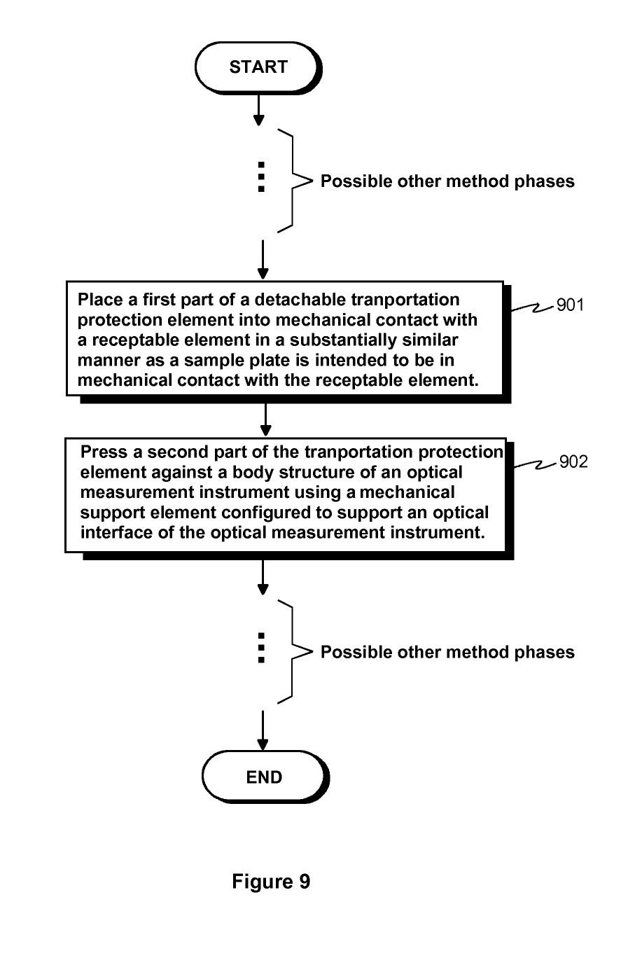

FIG. 9 shows a flow chart of a method according to an embodiment of the invention for equipping an optical measurement instrument of the kind described above with transportation protection. In the method according to this embodiment of the invention, the transportation protection element includes a first part and a second part connected to the first part in a flexible manner, and the method includes:
placing, in phase 901, the first part into mechanical contact with the receptable element in a substantially similar manner as a sample plate is intended to be in mechanical contact with the receptable element, and
pressing, in phase 902, the second part against the body structure with the aid of the first mechanical support element.

In a method according to an embodiment of the invention, the transportation protection element is made of elastic material and the first part of the transportation protection element is connected to the second part of the transportation protection element with strips of said elastic material.

The specific examples provided in the description given above should not be construed as limiting. Therefore, the invention is not limited merely to the embodiments described above.

1. An optical measurement instrument equipped with transportation protection, comprising:
a body structure (201, 301, 401, 501, 601, 701),
a first mechanical support element (202, 302, 402, 502, 602, 702) for supporting an optical interface capable of directing an excitation beam to a sample to be measured and/or to collect emission beam from the sample,
a receptable element (211, 311, 411, 511, 611, 711) for receiving a sample plate and being located in an area between the first mechanical support element and the body structure,
second mechanical support elements (207-210, 307-310, 407, 408, 507, 508, 607, 608, 707-710) arranged to moveably support the receptable element with respect to the body structure, and
a transportation protection element (212-215, 312-314, 412, 512-515, 612, 712) that is detachable and arranged to mechanically restrict movement of the receptable element with respect to the body structure,
characterized in that the transportation protection element is arranged to be pressed between the first mechanical support element and the body structure.

2. An optical measurement instrument according to claim 1, wherein the transportation protection element (212-215, 312-314, 412, 512-515, 612) is located with respect to the receptable element in a substantially similar manner as a sample plate is intended to locate with respect to the receptable element.

3. An optical measurement instrument according to claim 1, wherein the transportation protection element comprises:
a first part (213, 313) in mechanical contact with the receptable element in a substantially similar manner as a sample plate is intended to be in mechanical contact with the receptable element, and
a second part (212, 312) connected to the first part in a flexible manner so as to allow the second part to be pressed against the body structure (201, 301) with the aid of the first mechanical support element (202, 302).

4. An optical measurement instrument according to claim 3, wherein the transportation protection element (312-314) is made of elastic material and the first part (313) of the transportation protection element is connected to the second part (312) of the transportation protection element with strips (314) of said elastic material.

5. An optical measurement instrument according to claim 1, wherein a surface of the transportation protection element that is in mechanical contact with the body structure is at least partially covered with anti-slip material.

6. An optical measurement instrument according to claim 1, wherein the optical measurement instrument comprises driving elements (203-206, 303-306, 403-406, 503-506, 703-706) for making the first mechanical support element (202, 302, 402, 502, 702) to press the transportation protection element (212-215, 312-314, 412, 512-515, 712) against the body structure (201, 301, 401, 501, 701).

7. An optical measurement instrument according to claim 6, wherein the driving elements comprise at least one threaded rod (203, 204) having a thread pitch angle so small that the threaded rod is self-locking by friction to a respective counterpart (205, 206) in the longitudinal direction of the threaded rod.

8. An optical measurement instrument according to claim 1, wherein the transportation protection element (612) is arranged to expand as a response to a control action directed to the transportation protection element in order to arrange the transportation protection element to be pressed between the first mechanical support element (602) and the body structure (601).

9. A method for equipping an optical measurement instrument with transportation protection, the optical measurement instrument comprising:
a body structure,
a first mechanical support element for supporting an optical interface capable of directing an excitation beam to a sample to be measured and/or to collect emission beam from the sample,
a receptable element for receiving a sample plate and being located in an area between the first mechanical support element and the body structure, and
second mechanical support elements arranged to moveably support the receptable element with respect to the body structure,
characterized in that the method comprises arranging (801, 901, 902) a detachable transportation protection element to be pressed between the first mechanical support element and the body structure so as to arrange the transportation protection element to mechanically restrict movement of the receptable element with respect to the body structure.

10. A method according to claim 9, wherein the transportation protection element is placed with respect to the receptable element in a substantially similar manner as a sample plate is intended to locate with respect to the receptable element.

11. A method according to claim 9, wherein the transportation protection element comprises a first part and a second part connected to the first part in a flexible manner, and the method comprises:
placing (901) the first part into mechanical contact with the receptable element in a substantially similar manner as a sample plate is intended to be in mechanical contact with the receptable element, and
pressing (902) the second part against the body structure with the aid of the first mechanical support element.

12. A method according to claim 11, wherein the transportation protection element is made of elastic material and the first part of the transportation protection element is connected to the second part of the transportation protection element with strips of said elastic material.

13. A method according to claim 9, wherein a surface of the transportation protection element that is in mechanical contact with the body structure is at least partially covered with anti-slip material.

14. A method according to claim 9, wherein the method comprises pressing, with the aid of the first mechanical support element, the transportation protection element against the body structure.

15. A method according to claim 14, wherein the first mechanical support element is pressed against the transportation protection element using least one threaded rod having a thread pitch angle so small that the threaded rod is self-locking by friction to a respective counterpart in the longitudinal direction of the threaded rod.

16. A method according to claim 9, wherein the method comprises expanding the transportation protection element in order to arrange the transportation protection element to be pressed between the first mechanical support element and the body structure.

17. An arrangement for equipping an optical measurement instrument with transportation protection, the optical measurement instrument comprising:
a body structure (201, 301, 401, 501, 601, 701),
a first mechanical support element (202, 302, 402, 502, 602, 702) for supporting an optical interface capable of directing an excitation beam to a sample to be measured and/or to collect emission beam from the sample,
a receptable element (211, 311, 411, 511, 611, 711) for receiving a sample plate and being located in an area between the first mechanical support element and the body structure, and
second mechanical support elements (207-210, 307-310, 407, 408, 507, 508, 607, 608, 707-710) arranged to moveably support the receptable element with respect to the body structure,
characterized in that the arrangement comprises a detachable transportation protection element (212-215, 312-314, 412, 512-515, 612, 712) arranged to be pressed between the first mechanical support element and the body structure so as to mechanically restrict movement of the receptable element with respect to the body structure.

18. A method according to claim 10, wherein the method comprises pressing, with the aid of the first mechanical support element, the transportation protection element against the body structure.

19. An optical measurement instrument according to claim 2, wherein the optical measurement instrument comprises driving elements (203-206, 303-306, 403-406, 503-506, 703-706) for making the first mechanical support element (202, 302, 402, 502, 702) to press the transportation protection element (212-215, 312-314, 412, 512-515, 712) against the body structure (201, 301, 401, 501, 701).

20. An optical measurement instrument according to claim 3, wherein the optical measurement instrument comprises driving elements (203-206, 303-306, 403-406, 503-506, 703-706) for making the first mechanical support element (202, 302, 402, 502, 702) to press the transportation protection element (212-215, 312-314, 412, 512-515, 712) against the body structure (201, 301, 401, 501, 701).
